(19) United States
(12) Patent Application Publication
(10) Pub. No.: US 2026/0266688 A1
(43) Pub. Date: Sep. 10, 2026

(54) Method and System for Monitoring a Slide Bearing

(71) Applicant: Rheinisch-Westfälische Technische Hochschule (RWTH) Aachen, Aachen (DE)

(72) Inventors: Florian König, Aachen (DE); Georg Jacobs, Raeren (DE)

(21) Appl. No.: 18/869,414

(22) PCT Filed: May 26, 2023
(86) PCT No.: PCT/EP2023/064209

§ 371 Date: Nov. 26, 2024

(30) Foreign Application Priority Data
Jun. 1, 2022 (DE) 10 2022 113 888.7

(51) Int. Cl. G01M 13/045; F01D 21/00; F03D 17/00

(52) U.S. Cl. CPC G01M 13/045; F01D 21/003; F03D 17/005; F03D 17/032; F05B 2260/80; F05D 2260/80

(57) ABSTRACT

A method for monitoring a slide bearing of a wind turbine, a steam turbine or a compressor includes at least the following steps: detecting a structure-borne sound signal of the slide bearing by means of a structure-borne sound sensor; transforming the detected structure-borne sound signal into a time-frequency domain, in particular by means of continuous wavelet transformation; identifying anomalies in the transformed structure-borne sound signal by means of an autoencoder; and generating anomaly data depending on identified anomalies. A system for monitoring a slide bearing is also disclosed.

### CROSS-REFERENCE TO RELATED APPLICATIONS

This application is a U.S. National Phase of International Patent Application No. PCT/EP2023/064209, entitled “METHOD AND SYSTEM FOR MONITORING A PLAIN BEARING”, filed on May 26, 2023, which claims priority to German Patent Application No. 102022113888.7, filed Jun. 1, 2022, the entire contents of each which are incorporated herein by reference in their entirety.

### FIELD OF THE INVENTION

The present invention relates to a method for monitoring a slide bearing of a wind turbine, a steam turbine or a compressor. In addition, the invention relates to a system for monitoring a slide bearing of a wind turbine, a steam turbine or a compressor.

### BACKGROUND OF THE INVENTION

In wind turbines, steam turbines and compressors, slide bearings are usually installed, for example in order to mount a rotor and/or as part of a planetary gear. Due to the frequent and mostly unpredictable start-up and run-out, especially in these systems and devices, the slide bearing is often in a wear-critical and fatigue-critical operating state. Accordingly, an unexpectedly early failure of the slide bearing may occur. As a result, undesired downtimes occur, which may cause high costs and require a flexible conducting of repairs. Especially in offshore wind turbines, however, a timely repair due to bad weather and long distances is usually not possible at all. In order to prevent an unexpected failure, the corresponding slide bearings can be frequently replaced in planned manner. As a result, however, slide bearings are also replaced which are not worn at all and are thus still suitable for a longer further use. In addition, a planned replacement also prevents a use over a certain period of time. Accordingly, high costs also result.

A further possibility is a condition monitoring of the slide bearing in order to be able to detect wear and fatigue early. Then, a needs-based maintenance before a bearing damage or directly after a bearing damage and before further consequential damage is possible. However, the condition monitoring can be difficult and not very reliable due to dynamically changing operating states and vibrations. In addition, an analysis of large data quantities can be necessary, whereby the monitoring itself can also be very costly. The bearing monitoring can take place, for example, on the basis of a temperature monitoring. However, this form of monitoring is only suitable for some bearing types. For example, a condition monitoring of slide bearings with a polymer running layer can be very unreliable, since respective plastics used therein are only very poorly thermally conductive. As a result, failure-relevant regions with excess temperatures cannot or only very poorly be detected and, despite monitoring, a failure of the slide bearing can occur without prior warning.

### SUMMARY OF THE INVENTION

A first aspect of the invention relates to a method for monitoring a slide bearing of a wind turbine, a steam turbine or a compressor. A slide bearing can be a bearing type in which parts moving relative to one another can have a direct contact depending on the operating point. At high relative speeds, the parts moving relative to one another can be separated by a lubricating film. The slide bearing can, for example, rotatably mount a rotor of the wind turbine, the steam turbine or the compressor. The slide bearing can, for example, be a main bearing, a gear bearing or a bearing of a periphery. The slide bearing can, for example, be part of a gear, in particular a planetary gear. For example, the slide bearing can rotatably mount a planet gear on a planet pin of a planet carrier. A wind turbine can be a system which converts kinetic energy from wind into electrical energy. For example, the wind turbine can comprise a tower with a rotor rotatably mounted thereon. A steam turbine can be a heat engine for converting thermal energy of a water vapor into rotational energy. A generator for generating electricity can thus be driven. The steam turbine can, for example, be configured as part of a power plant. The steam turbine can also be configured as a gas turbine for other fluids. A rotor of the steam turbine can, for example, comprise respective turbine blades. A compressor can be a machine which supplies mechanical work to a gas, for example, by compressing. The compressor can be configured as part of a power plant or an aircraft engine. The slide bearing can, for example, also form part of a turbine of a hydroelectric power plant.

The method comprises a step of detecting a structure-borne sound signal of the slide bearing by means of a structure-borne sound sensor. A structure-borne sound can be a sound which propagates in a solid body. For example, the structure-borne sound can be configured as a longitudinal wave and/or transverse wave. The structure-borne sound can correspond to an oscillation of at least a partial region of the slide bearing or also of the entire slide bearing. The structure-borne sound signal can comprise frequency information and/or amplitude information. The structure-borne sound signal can, for example, be detected continuously or discontinuously. Conclusions about an operating condition, wear and also damage to the slide bearing may be possible with the structure-borne sound signal. In an analytical evaluation, however, it may be necessary to separate from one another portions of the structure-borne sound signal with information regarding a bearing condition and portions of the structure-borne sound signal which are caused according to noise or by irrelevant environmental influences.

The structure-borne sound sensor can, for example, be configured as a piezoelectric element and/or as a contact microphone. The structure-borne sound sensor can be fastened to a part of the slide bearing or a further component contacted therewith for detecting the structure-borne sound signal. The signal quality can be particularly good due to the fastening to the slide bearing. For example, the structure-borne sound sensor can be arranged on one of the bearing pins of the planetary gear of the wind turbine or on a gear housing of the planetary gear of the wind turbine.

The method can also detect a plurality of structure-borne sound signals, for example of different slide bearings. For example, an associated structure-borne sound sensor can be provided per slide bearing. The method can also be configured to monitor a plurality of slide bearings simultaneously.

The method comprises a step of transforming the detected structure-borne sound signal into a time-frequency domain. The transformed structure-borne sound signal can, for example, allow an amplitude to be assigned to a respective time frequency or a respective frequency range in a certain time interval. The signal can be detected in a high locality in the time range and frequency range. The transformed structure-borne sound signal can allow a pictorial representation of the detected structure-borne sound signal and/or a processing and storage of the detected signal in an image format. Respective structure-borne sound information can be strongly compressed by the transformation. This can considerably reduce the effort in the data processing and/or data transmission. The transformation can be done, for example, by means of continuous wavelet transformation. Other transformations are also possible, for example generally by means of wavelet transformation. The wavelet transformation can be a linear time-frequency transformation. The wavelet transformation can be composed of a wavelet analysis, which denotes a transition of a time representation into a wavelet representation, and a wavelet synthesis, which denotes a back transformation of the wavelet transformation into the time representation. The wavelet transformation can serve for data compression and signal processing. The time-frequency domain can greatly simplify an automatic evaluation of the structure-borne sound signal. Compared to a Fourier transformation, the transformation by means of continuous wavelet transformation is able to detect signals with a high locality in the time and frequency range, as typically in the case of structure-borne sound signals, with a high quality and efficiency.

The method comprises a step of identifying anomalies in the transformed structure-borne sound signal by means of an autoencoder. Due to using the autoencoder, a costly analytical filtering of the structure-borne sound signal, for example in order to separate portions of the structure-borne sound signal with information regarding a bearing condition and portions of the structure-borne sound signal which are caused according to noise or by irrelevant environmental influences, may be unnecessary. An anomaly may, for example, be an operating state which does not correspond to a normal state, and/or an operating state with increased wear. An anomaly may also be a state in which the slide bearing has failed and/or begins to wear strongly. The anomaly may be a wear-critical and/or fatigue-critical state of the slide bearing. For example, an anomaly may be a state in which the parts of the slide bearing moved relative to one another are in a solid body friction state with one another, although a rotational speed of the slide bearing should already generate a stable oil film. An autoencoder may be an artificial neural network. The autoencoder may be configured for dimension reduction of the transformed structure-borne sound signal. The autoencoder may be trained to ignore insignificant data when identifying the anomalies. The autoencoder may, for example, only take into account re-productions of respective anomalies in the transformed structure-borne sound signal. The autoencoder may, for example, be configured as a deep convolutional autoencoder which comprises a CNN as a neural network. The CNN may, for example, learn a structure in the input data. Local patterns can be detected by convolution filters, wherein the transformed structure-borne sound signals can be treated like images by the CNN. Respective features may, for example, be correlated locally, that is to say with respect to time and frequency. The autoencoder may be configured to classify the transformed structure-borne sound signal as an anomaly state or normal state in order to identify anomalies. The autoencoder may receive the transformed structure-borne sound signal as input data. The autoencoder may reconstruct the input data in its neural network, wherein strong deviations indicate an anomaly as a result. These deviations may be recorded and/or provided as output. A degree of deviation may be output as an anomaly characteristic variable. The identification may include a detection of anomalies and/or a classification of anomalies. The autoencoder may be configured as an autoencoder trained without monitoring, whereby its training and thus the implementation can be particularly cost-effective.

Using the autoencoder for identifying anomalies in the transformed structure-borne sound signal may make it possible to monitor the slide bearing efficiently automatically. Only small data quantities and a low computing power are necessary. For example, a costly human evaluation, human monitoring and an analytical data evaluation of the structure-borne sound signal are not necessary. The autoencoder can be particularly efficient in evaluating signals in the time-frequency domain. In addition, no provision of features in structure-borne sound signals is necessary, on the basis of which anomalies can be identified. Rather, the autoencoder can detect and/or learn anomalies on the basis of known normal conditions. No extraction of characteristics from the data set itself is necessary in order to identify anomalies. The autoencoder can automatically extract relevant information from the transformed structure-borne sound signal, despite many interference signals.

By early detection of damage on the basis of structure-borne sound signals, wear of the slide bearing can be detected very early. For example, detection of damage is possible on the basis of the following possibilities in descending order: structure-borne sound-based, vibration-based, bearing oil contamination-based, airborne sound-based, temperature-based, smoke-based, and on the basis of an actual failure. Clearly, in the case of structure-borne sound-based monitoring, a particularly early prior warning against an imminent failure is possible, in particular earlier than in the case of other methods.

The method is particularly suited for wind turbines, steam turbines and compressors. Due to external and/or random influences, such as changes in the fluid properties in the compressor and the steam turbine and turbulences in the wind at the wind turbine, an analytical evaluation is extremely complex and costly and, in some cases, even not possible at all. In addition, structure-borne sound is often very device-specific. For example, two structurally identical wind turbines can comprise different structure-borne sound signals in the normal state under the same operating conditions. Nevertheless, the auto-encoder can learn in a simple manner to identify anomalies in each case. Hitherto, on the other hand, structure-borne sound-based monitoring of slide bearings in such systems and devices was not possible or was associated with an uneconomically high effort.

The method comprises a step of generating anomaly data depending on identified anomalies. The anomaly data may, for example, be the data recorded and/or provided as output by the autoencoder. The anomaly data may be or comprise a set of transformed or untransformed structure-borne sound signals in which an anomaly was identified. The anomaly data may comprise a number of identified anomalies, such as being a type of counter. The number may be cumulative. The anomaly data may comprise the degree of deviation as an anomaly characteristic variable. The anomaly data may, for example, comprise information regarding the number, time, kind, type and/or severity of the identified anomaly. The anomaly data may be provided as output by the autoencoder or by an evaluation device which is controlled depending on anomalies identified by the autoencoder. The anomaly data may correspond to the output data of the autoencoder. The anomaly data may comprise warning information regarding a bearing condition, outputs of probabilities of bearing failure and/or further characteristic variables.

The system may comprise a control device which generates control data depending on the anomaly data. The control device can be configured to control the wind turbine or generally the device whose slide bearing is monitored with the control data. Alternatively or additionally, the control device can be configured to control an output device with the control data. For example, in the case of certain anomaly data, a switching off or a reduction of a maximum power can take place. The output device can be configured to control a display depending on the control data. For example, the anomaly data can thus be output optically or acoustically.

In an embodiment of the method, it is provided that the autoencoder is configured as a deep convolutional autoencoder. This type of autoencoder can be particularly efficient in the evaluation of the transformed structure-borne sound signals. In addition, this type of autoencoder can learn particularly reliably not to take into account interfering signals.

In an embodiment of the method, it is provided that the autoencoder is trained to identify deviations from a system-specific normal state as anomaly. The normal state may be a state which is not critical for wear and/or fatigue of the slide bearing. For a simple implementation, it may, for example, be assumed during the training of the autoencoder that a newly installed slide bearing or a freshly maintained slide bearing is in the normal state. The autoencoder can thus, for example, be trained directly after commissioning of the wind turbine or of another device with the slide bearing to be monitored with the first operating minutes, operating hours, operating days or even operating weeks. By taking into account a system-specific normal state, a respective system-specific structure-borne sound transmission behavior can be taken into account in order to identify anomalies particularly reliably. For example, the autoencoder may only be trained with the normal state. Transformed structure-borne sound signals from a system-specific normal state of the slide bearing can be used for training the autoencoder. Alternatively, the autoencoder may also be trained on a test bench, with historical data of other systems and/or devices and with simulated data. The autoencoder may, for example, be trained or have been trained with a back propagation method. The input data for training may also be initially weighted in order to improve the training.

In an embodiment of the method, it is provided that the method further comprises a step of digitizing the structure-borne sound signal before its transformation. The structure-borne sound signal can, for example, be detected as an analog signal. Further data processing is simplified by the digitization. The digitization can take place, for example, before the transformation of the structure-borne sound signal into the time-frequency domain.

In an embodiment of the method, it is provided that only structure-borne sound signals in a frequency range greater than 30 kHz, in particular greater than 50 kHz, and/or less than 1.3 MHz, in particular less than 1 MHz, are used for the detection of anomalies. Below 30 kHz, in particular below 50 kHz, structure-borne sound signals are not very suitable for identifying anomalies. Above 1.3 MHz, in particular above 1 MHz, the structure-borne sound signals hardly contain any information or no information relating to additional anomalies. Due to the fact that only a corresponding frequency range is taken into account, the reliability of the anomaly identification can be particularly high. In addition, a data quantity to be evaluated can thus be kept. The frequency range can be selected, for example, during the digitization and/or during the transformation. The frequency range can, however, also be predetermined, for example, directly during the detection of the structure-borne sound signal by filtering. Signals outside the frequency range are, for example, no longer supplied to the autoencoder as input data. Alternatively, the structure-borne sound sensor can also be configured to detect only structure-borne sound signals in the desired frequency range.

In an embodiment of the method, it is provided that the structure-borne sound signals are detected discontinuously in certain time intervals. As a result of the discontinuous detection, a data volume and an effort for the evaluation can be kept low. In contrast, in the case of a continuous detection or monitoring, the anomaly identification by the auto-encoder can be difficult.

For example, the time interval is 0.1 to 120 seconds, in particular 1 second to 60 seconds. In the case of such a measurement duration, for example, firstly an anomaly can be easily detected and secondly it can be easily avoided that two anomalies are detected together, in particular in the case of typical operating conditions of wind turbines. This facilitates the further evaluation. In addition, effort and power consumption during the monitoring can thus be low.

For example, a measurement duration is 0.1 to 64 milliseconds, in particular 1 to 32 milliseconds. In the case of such a measurement duration, anomalies during the operation of slide bearings, in particular in wind turbines, can typically be particularly easily detected. For example, such a measurement duration is sufficient to reliably detect wear-critical and fatigue-critical states in the detected structure-borne sound signal. At the same time, this short measurement duration reduces the fact that changes in the operating conditions, for example due to gusts, incorrectly indicate an anomaly.

In an embodiment of the method, it is provided that the method comprises a step of a wear calculation and/or a fatigue calculation of the slide bearing by means of a recurrent neural network. The recurrent neural network may receive the generated anomaly data as input data and generate a wear characteristic value and/or a fatigue characteristic value as output data. A wear calculation can, for example, be configured to output a remaining service life of the slide bearing. A fatigue calculation can, for example, be configured to output a probability of a failure due to material fatigue of the slide bearing. By means of the recurrent neural network, a prediction can, for example, be made as to when the slide bearing will fail, in particular with what probability. On this basis, a maintenance and/or a replacement of the slide bearing can be planned in order to enable a cost-efficient and reliable operation.

In an embodiment of the method, it is provided that the recurrent neural network receives additional state data, such as an operating temperature and/or a rotational speed, as input data. The determined wear characteristic value and/or the determined fatigue characteristic value can thus be particularly informative. As a result, operating conditions of the slide bearing can be taken into account. The state data may, for example, comprise information about an environmental condition of the slide bearing, an operating condition of the slide bearing and/or an operating condition of the system or device in which the slide bearing is used.

In an embodiment of the method, it is provided that in the method the recurrent neural network has been trained with a training method. The training method may comprise a step of providing anomaly data. The anomaly data may, for example, be historical and/or simulated anomaly data, also of other facilities. The anomaly data provided for the training may relate to a slide bearing of the same type or also to a slide bearing different from the monitored slide bearing. The training method may comprise a step of providing wear characteristic values and/or fatigue characteristic values corresponding to the anomaly data. The wear characteristic values and/or fatigue characteristic values corresponding to the anomaly data may, for example, be corresponding historical and/or simulated wear characteristic values and/or fatigue characteristic values. The provided data and characteristic values may also have been determined on a test bench. The training method may comprise a step of generating a training data set. The training data set may comprise the provided anomaly data as input data. The training data set may comprise the provided wear characteristic values and/or the provided fatigue characteristic values as output data. The training method may comprise a step of training the recurrent neural network in order to teach a relationship between the anomaly data and the wear characteristic values and/or fatigue characteristic values.

In an embodiment of the method, it is provided that the transformation of the structure-borne sound signal takes place locally, in particular by a local computing device. The local computing device may, for example, be a computer which is installed at the wind turbine, steam turbine or the compressor and/or is connected directly by wire to sensors and/or actuating elements of this installation or device. The structure-borne sound signal can, for example, be compressed by the transformation, whereby a data transmission for an evaluation in another computing device is possible in a simple manner. For example, the further evaluation can take place at a central server, in particular for a plurality of slide bearings also of different installations or devices. As a result, a central monitoring and/or maintenance planning is possible in a simple manner. The digitization can also take place locally, in particular by the local computing device.

The method may further comprise a step of sending the transformed structure-borne sound signal to a central server, wherein the autoencoder for identifying anomalies is implemented on the central server. As a result, a particularly large computing power can be made available there in a cost-effective manner. In addition, the method can thus be particularly efficient if a plurality of slide bearings of different installations or devices are monitored, since the central server can then also be utilized to capacity even despite, for example, only intermittent detection. Alternatively, the autoencoder can also be implemented on the local computing device.

The method may further alternatively or additionally comprise a step of sending the generated anomaly data to the central server. In particular, the recurrent neural network for wear calculation and/or fatigue calculation can be implemented on the central server. The anomaly data are thus available directly centrally for a further evaluation. Alternatively, the recurrent neural network can also be implemented on the local computing device.

The sending can take place, for example, by radio, in particular cellular network. The sending can also take place by wire. For example, common transmission protocols and networks can be used, such as cellular network and/or the Internet. A data transmission device can be provided for the sending. The data transmission device can also be configured for receiving. For example, respective training data for the autoencoder and/or the recurrent neural network can also be received via the transmission device.

A second aspect of the invention relates to a system for monitoring a slide bearing of a wind turbine, a steam turbine or a compressor. The system can be configured for carrying out a method according to the first aspect. Corresponding features and advantages of the first aspect can also form features and advantages of the further aspect and vice versa.

The system comprises a structure-borne sound sensor. The structure-borne sound sensor is configured to detect a structure-borne sound signal of the slide bearing. A plurality of structure-borne sound sensors can also be provided, which together detect the structure-borne sound signal of the slide bearing. For example, one or more structure-borne sound sensors can be fastened to a bearing housing and/or a planet pin of a planetary gear of a wind turbine. Respective structure-borne sound sensors can be configured to be fastened to a shaft and/or the slide bearing.

The system comprises a computing system. The computing system can comprise one or more computing devices which are, for example, communicatively connected to one another. A computing device can, for example, be configured as a computer or microprocessor. The computing system is configured to transform the detected structure-borne sound signal into a time-frequency domain, to identify anomalies in the transformed structure-borne sound signal by means of an autoencoder and to generate anomaly data depending on identified anomalies. The computing system can comprise a data transmission device, such as a network card, a data storage device, such as a hard disk, and/or an output device, such as a screen.

In an embodiment of the system, it is provided that the computing system comprises a local computing device installed at the wind turbine, the steam turbine or the compressor. The local computing device can be compact and cost-effective. Suitable examples are a Raspberry Pi computer and an Arduino development board. The computing system can comprise a central server and a data transmission device for transmitting data from the local computing device to the central server. The local computing device can be configured to transform the detected structure-borne sound signal into a time-frequency domain. The local computing device can be configured to digitize the detected structure-borne sound signal. The central server or the local computing device can be configured to carry out a wear calculation and/or a fatigue calculation of the slide bearing by means of a recurrent neural network. The data transmission device can, for example, transmit respective outputs of the local computing device to the local server, for example transformed structure-borne sound signals, anomaly data and/or wear characteristic values and/or fatigue characteristic values. Respective data can be stored on the data storage device. The data storage device can, for example, comprise a storage module of the central server and/or a further storage module of the local computing device. Data can be stored only locally or centrally or else redundantly locally and centrally.

The local computing device can be configured to identify anomalies in the transformed structure-borne sound signal by means of an autoencoder and to generate anomaly data depending on identified anomalies. The autoencoder can be implemented on the local computing device. In this case, for example, respective anomaly data can be transmitted to the central server. Optionally, the recurrent neural network can also be implemented on the local computing device. In this case, for example, respective wear characteristic values and/or respective fatigue characteristic values can be transmitted to the central server.

Alternatively, the central server can be configured to identify anomalies in the transformed structure-borne sound signal by means of an autoencoder and to generate anomaly data depending on identified anomalies. The autoencoder can be implemented on the central server. In this case, for example, respective transformed structure-borne sound signals can be transmitted to the central server. Optionally and in this case, the recurrent neural network can be implemented on the central server.

### BRIEF DESCRIPTION OF THE DRAWINGS

FIG. 1 illustrates a method for monitoring a slide bearing of a wind turbine, a steam turbine or a compressor; and

FIG. 2 schematically illustrates a system for monitoring a slide bearing of a wind turbine, a steam turbine or a compressor.

### DETAILED DESCRIPTION OF EMBODIMENTS

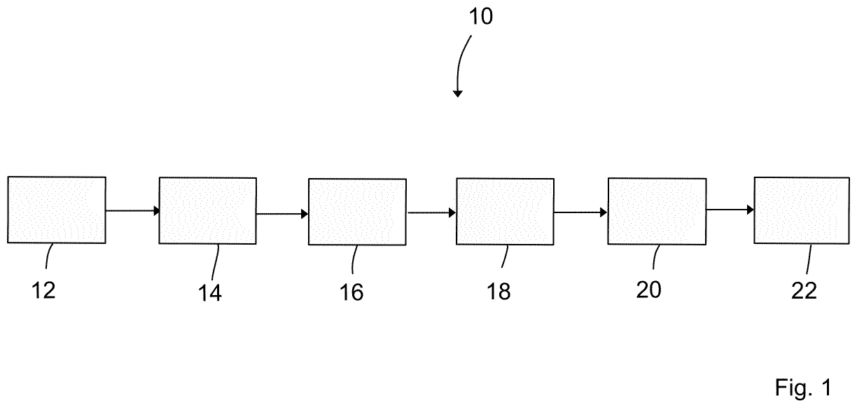

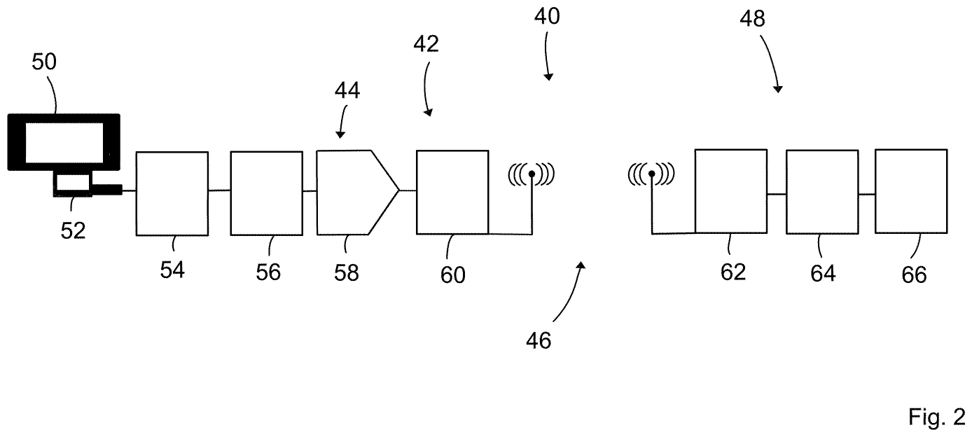

FIG. 1 illustrates a method 10 for monitoring a slide bearing 50 of a gear of a wind turbine, a steam turbine or a compressor, wherein the slide bearing 50 is schematically illustrated in FIG. 2. In step 12, a structure-borne sound signal of the slide bearing 50 is detected by means of a structure-borne sound sensor 52 fastened thereto, wherein the structure-borne sound sensor 52 is also schematically illustrated in FIG. 2.

The detected structure-borne sound signal is digitized in a step 14 of the method 10. The digitized structure-borne sound signal is transformed in a step 16 of the method 10 into a time-frequency domain by means of a continuous wavelet transformation. In a step 18 of the method 10, anomalies in the transformed structure-borne sound signal are identified by means of an autoencoder. Anomaly data is generated in a step 20 of the method 10 depending on identified anomalies. This generated anomaly data is made available to a recurrent neural network as input data. The recurrent neural network is trained to generate a wear characteristic value and/or a fatigue characteristic value as output data in a step 22 of the method 10 in response to this input data in order to carry out a wear calculation and/or a fatigue calculation of the slide bearing 50 by means of the recurrent neural network. Thus, a failure of the slide bearing 50 can be predicted early and/or a remaining service life of the slide bearing 50 can be calculated with little effort in order to accordingly plan a maintenance and/or a replacement of the slide bearing 50.

FIG. 2 schematically illustrates a system 40 for monitoring the slide bearing 50. The system 40 is configured to carry out the method 10. The system 40 accordingly comprises the structure-borne sound sensor 52. In addition, the system 40 comprises a computing system 42. The computing system 40 comprises a computing device 44 installed locally at the wind turbine, the steam turbine or the compressor. The local computing device 44 comprises a module 54 for receiving the detected structure-borne sound signal, which is communicatively connected to the structure-borne sound sensor 52, for example by means of radio or cable. The local computing device 44 comprises a module 56, by means of which the detected structure-borne sound signal received by the local computing device 44 is digitized. In addition, the local computing device 44 comprises a module 58, by means of which the detected and digitized structure-borne sound signal is transformed into a time-frequency domain by means of continuous wavelet transformation. By means of the transformation, a data quantity is considerably reduced, without, however, a reduction or only a small reduction of the data quality occurring.

Furthermore, the computing system 42 comprises a data transmission device 46 with a transmission module 60 connected to the local computing device 44. In addition, the computing system 42 comprises a central server 48, wherein a further transmission module 62 of the data transmission device 46 is connected to the central server 48. By means of the data transmission device 46, the transformed structure-borne sound signal can be transmitted to the central server 48. The data transmission device 46 transmits respective data, for example, by means of cellular network and/or a land network.

The central server 48 comprises a module 64, on which the autoencoder is implemented and by means of which the central server 48 identifies anomalies in the transmitted and transformed structure-borne sound signal. In addition, the central server 48 comprises a module 66, on which the recurrent neural network is implemented and by means of which the central server 48 carries out the wear calculation and/or the fatigue calculation of the slide bearing 50.

Due to using the central server 48, costly calculations can be carried out centrally and cost-effectively, in particular also for monitoring different slide bearings. The data transmission interface can also be provided at another location of the computing system 42. For example, instead of the central server 48, the local computing device 44 can comprise the module 64 with the autoencoder implemented thereon, in order to further reduce a data quantity to be transmitted.

### REFERENCE SIGNS

10 Method
12 Step of Detecting
14 Step of Digitizing
16 Step of Transforming
18 Step of Anomaly Identifying
20 Step of Generating Anomaly Data
22 Step of Determining a Wear and/or Fatigue Characteristic Value
40 System for Monitoring a Slide Bearing
42 Computing System
44 Local Computing Device
46 Data Transmission Device
48 Central Server
50 Slide Bearing
52 Structure-borne Sound Sensor
54 Structure-borne Sound Signal Receiving Module
56 Digitization Module
58 Transformation Module
60 Local Transmission Module
62 Central Transmission Module
64 Autoencoder Module
66 Wear Calculation and/or Fatigue Calculation Module

1-12. (canceled)

13. A method for monitoring a slide bearing of a wind turbine, a steam turbine or a compressor, wherein the method comprises at least the following steps:
detecting a structure-borne sound signal of the slide bearing by a structure-borne sound sensor;
transforming the detected structure-borne sound signal into a time-frequency domain;
identifying anomalies in the transformed structure-borne sound signal by an autoencoder;
generating anomaly data depending on identified anomalies.

14. The method according to claim 13, wherein the autoencoder is configured as a deep convolutional autoencoder.

15. The method according to claim 13, wherein:
the autoencoder is trained to identify deviations from a system-specific normal state as anomaly; and
transformed structure-borne sound signals from a system-specific normal state of the slide bearing are used for training the autoencoder.

16. The method according to claim 13, further comprising a step of digitizing the structure-borne sound signal before its transformation.

17. The method according to claim 13, wherein only structure-borne sound signals in a frequency range greater than 30 kHz and/or less than 1.3 MHz are used for the detection of anomalies.

18. The method according to claim 17, wherein only structure-borne sound signals in a frequency range greater than 50 kHz, and/or less than 1 MHz are used for the detection of anomalies.

19. The method according to claim 13, wherein the structure-borne sound signals are detected discontinuously in certain time intervals.

20. The method according to claim 19, wherein the time interval is 0.1 to 120 seconds, or 1 second to 60 seconds,

21. The method according to claim 13, wherein a measurement duration is 0.1 to 64 milliseconds, or 1 to 32 milliseconds.

22. The method according to claim 13, further comprising a step of a wear calculation and/or a fatigue calculation of the slide bearing by a recurrent neural network, wherein the recurrent neural network receives the generated anomaly data as input data and generates a wear characteristic value and/or a fatigue characteristic value as output data.

23. The method according to claim 22, wherein the recurrent neural network receives additional state data as input data.

24. The method according to claim 23, wherein the additional state data is an operating temperature and/or a rotational speed.

25. The method according to claim 22, wherein the recurrent neural network has been trained with a training method comprising the following steps:
providing anomaly data, in particular historical and/or simulated anomaly data;
providing wear characteristic values and/or fatigue characteristic values corresponding to the anomaly data, in particular corresponding historical and/or simulated wear characteristic values and/or fatigue characteristic values;
generating a training data set from the provided anomaly data as input data and the provided wear characteristic values and/or fatigue characteristic values as output data; and
training the recurrent neural network in order to teach a relationship between the anomaly data and the wear characteristic values and/or fatigue characteristic values.

26. The method according to claim 13, wherein:
the transformation of the structure-borne sound signal takes place locally, a local computing device;
and the method further comprises at least one step of the following steps:
sending the transformed structure-borne sound signal to a central server, wherein the autoencoder for identifying anomalies is implemented on the central server (48); and
sending the generated anomaly data to the central server.

27. The method according to claim 26, wherein a recurrent neural network for wear calculation and/or fatigue calculation is implemented on the central server.

28. The method according to claim 13, wherein the step of transforming the detected structure-borne sound signal into a time-frequency domain comprises transforming by continuous wavelet transformation.

29. A system for monitoring a slide bearing of a wind turbine, a steam turbine or a compressor, comprising:
a structure-borne sound sensor which is configured to detect a structure-borne sound signal of the slide bearing; and
a computing system;
wherein the computing system is configured to transform the detected structure-borne sound signal into a time-frequency domain, to identify anomalies in the transformed structure-borne sound signal by an autoencoder and to generate anomaly data depending on identified anomalies.

30. The system according to claim 29, wherein:
the computing system comprises a local computing device installed at the wind turbine, the steam turbine or the compressor, a central server and a data transmission device for transmitting data from the local computing device to the central server;
the local computing device is configured to transform the detected structure-borne sound signal into a time-frequency domain; and
the central server or the local computing device is configured to identify anomalies in the transformed structure-borne sound signal by an autoencoder and to generate anomaly data depending on identified anomalies.
